(19) United States
(12) Patent Application Publication
(10) Pub. No.: US 2016/0209733 A1
(43) Pub. Date: Jul. 21, 2016

(54) Holder for mobile devices to take self-portraits or selfies remotely

(71) Applicants: YOSHIKO AKAI, NEW YORK, NY (US); AKIRA YOSHIMURA, NEW YORK, NY (US); RADOSLAV P. KOTOROV, SOMERSET, NJ (US)

(72) Inventors: YOSHIKO AKAI, NEW YORK, NY (US); AKIRA YOSHIMURA, NEW YORK, NY (US); RADOSLAV P. KOTOROV, SOMERSET, NJ (US)

(21) Appl. No.: 14/991,758

(22) Filed: Jan. 8, 2016

Related U.S. Application Data
(60) Provisional application No. 62/105,093, filed on Jan. 19, 2015.

(51) Int. Cl. G03B 17/56; F16C 11/06; H04N 5/225; G03B 7/00; H04N 5/232; F16M 13/02; G03B 15/05

(52) U.S. Cl. CPC G03B 17/561; F16M 13/022; F16C 11/06; G03B 17/565; G03B 15/05; G03B 7/00; H04N 5/23203; H04N 5/2251; H04N 5/2256

(57) ABSTRACT

A holder for mobile devices with camera including phones or tablets for taking self-portraits or selfies remotely. The holder device comprises of a receptacle to insert and clamp securely a mobile device, where the clamping also establishes an electronic connection between the holder device and the mobile device. The holder device further comprises of controls to set functions and to operate the camera on the mobile device, means to be attached or positioned on vertical or flat surfaces such as walls, mirrors, doors, tables, posts, etc., and means to adjust the angle of the receptacle. In another embodiment of the invention, it can further comprise a built-in flash and a remote control. In another embodiment of the invention, the holder device comprises of motion and voice detection sensors to allow users to control and operate the camera with voice or gestures commands.

### CROSS REFERENCE OF RELATED APPLICATIONS

This invention claims priority, under 35 U.S.C. §120, to the U.S. Provisional Patent Application No. 62105093 to Akai, Yoshimura and Kotorov filed on Jan. 19, 2015, which is incorporated by reference herein.

### FIELD OF THE DISCLOSURE

The present invention relates generally to the technical field of systems, devices and methods for supporting mobile computing devices, and more specifically to a selfie apparatus for taking self-portraits remotely.

### BACKGROUND OF THE INVENTION

Self-portraits taken with mobile devices such as phones and tablets and commonly referred to as “selfies” have become an extremely popular form of photography. According to Samsung research conducted in 2014 selfies account for 30% of all photos taken. Other research organizations estimate that over 1 million selfies are being taken every day.

There are many problems associated with self-photography and the photographic industry has been developing innovative solutions since its very beginning. With traditional photographic equipment it is practically impossible to take a selfie without some type of support equipment for remote photography. However, mobile phones have made it somewhat easy for users to stretch their arms and take selfies. Yet, the human arm imposes some severe constraints on the field, angle and background of the selfie which impacts the overall quality and aesthetic appeal of the picture. Hence, the selfie stick was invented as a photographic extension of the human arm.

Selfie sticks have become very sophisticated equipment. Users can vary the length of the stick, the angle, the type of mobile device that can be attached, and other physical attributes. Some selfie sticks connect directly to the mobile device software. Thus, users can control the camera shutter directly from a button on the selfie stick.

Despite all the innovations, selfie sticks remain limited to the type of portraits that users can take with them. It is hard for users to take full body self-portraits with selfie sticks or to vary their body posture if they want to take more fashion-oriented pictures.

Thus a new type of self-photography with mobile phones has emerged that people refer to as “mirror selfies.” In this type of photography the user stands in front of a mirror holding a mobile phone in one hand, adopts a particular pose and snaps a picture of the reflection in the mirror. While this allows users to take full body portraits, the quality of the picture is somewhat compromised as the holding of the mobile phone constrains the posture. The mobile phone also appears in the picture. Furthermore, the need for a mirror constrains the environment in which full body selfies can be taken. User cannot take pictures outdoors or in rooms where there are no mirrors. The present invention provides a mountable selfie apparatus to solve these problems.

### SUMMARY OF THE INVENTION

In accordance with the embodiments described herein, an apparatus is disclosed for taking full body selfies with a mobile device. This summary is not an extensive overview, and it is not intended to identify key/critical elements or delineate the scope thereof. Its sole purpose is to present some concepts in a simplified form as a prelude to more detailed description that is presented later.

The apparatus is designed to hold a mobile device and to permanently or temporarily attach it to different surfaces such as flat surfaces, edges of objects, and poles. By attaching the apparatus to any surface the user is able to walk away from the camera and to take a full body selfie in any desired posture.

The apparatus comprises a mobile device holder for users to insert a mobile phone or another mobile device with which the selfie will be taken. The mobile device holder has a ball socket joint that attaches to a mounting plate. The ball socket joint allows the user to vary the vertical and the horizontal angle of the device holder. The mounting plate can be attached to different surfaces via a system of different attachments. Two keyholes can be used to permanently attach the mounting plate to a wall, a door or any other flat surface using screws. The same keyholes can be used to connect an elastic band with two metal pins at both ends to attach the mounting plate temporarily to a tree, a pole, or another vertical rounded or rectangular beam. Another clamp attachment with an interlocking groove allows the user to insert the mounting plate and temporarily clamp it to a door, a table or an edge of an object.

The apparatus further provides means to attach to the mounting plate picture enhancing attachments such as flashlights that can be positioned at different angles.

### BRIEF DESCRIPTION OF THE DRAWINGS

FIG. 1A is a perspective view of the device holder component.

FIG. 1B illustrates insertion of a mobile device into the device holder component.

FIG. 1C shows the ball socket joint insert at the back of the device holder component.

FIG. 1D shows a device holder component with remote camera controls.

FIG. 2A is a perspective view of the mounting plate component.

FIG. 2B is a front view of the mounting plate component.

FIG. 3A is a perspective view of the assembled apparatus.

FIG. 3B is a side view of the assembled apparatus.

FIG. 3C is a side view of a wall-mounted apparatus holding a mobile device.

FIG. 3D is a front view of a wall-mounted apparatus holding a mobile device.

FIG. 3E shows the left to right rotation of the apparatus.

FIG. 3F shows the front to back rotation of the apparatus.

FIG. 4A shows a railing rider attachment for the apparatus.

FIG. 4B shows the railing rider attachment mounted on a metal pole.

FIG. 4C shows the apparatus mounted on a metal pole.

FIG. 4D shows a user taking a selfie with the apparatus mounted on a metal pole.

FIG. 5A shows an elastic band attachment for pole mounting.

FIG. 5B illustrates the pole mounting with the elastic band attachment.

FIG. 5C shows connecting the elastic band attachment to the mounting plate component.

FIG. 5D shows the apparatus connected to the elastic band attachment.

FIG. 5E shows a user taking a selfie with the apparatus attached to an outdoor pole.

FIG. 6A shows a clamp attachment for the apparatus.

FIG. 6B shows the clamp attachment attached to the edge of an object.

FIG. 6C shows a user taking a selfie with the apparatus in front of a door mirror.

FIG. 7A shows a photo lighting attachment.

FIG. 7B illustrates connecting the photo lighting attachment to the mounting plate component.

FIG. 7C shows the attached photo lighting attachment to the mounting plate component.

FIG. 7D shows the assembling of the apparatus with a photo lighting attachment.

FIG. 7E shows the user taking a selfie with the apparatus with photo lighting and clamp attachments.

### DETAILED DESCRIPTION OF THE INVENTION

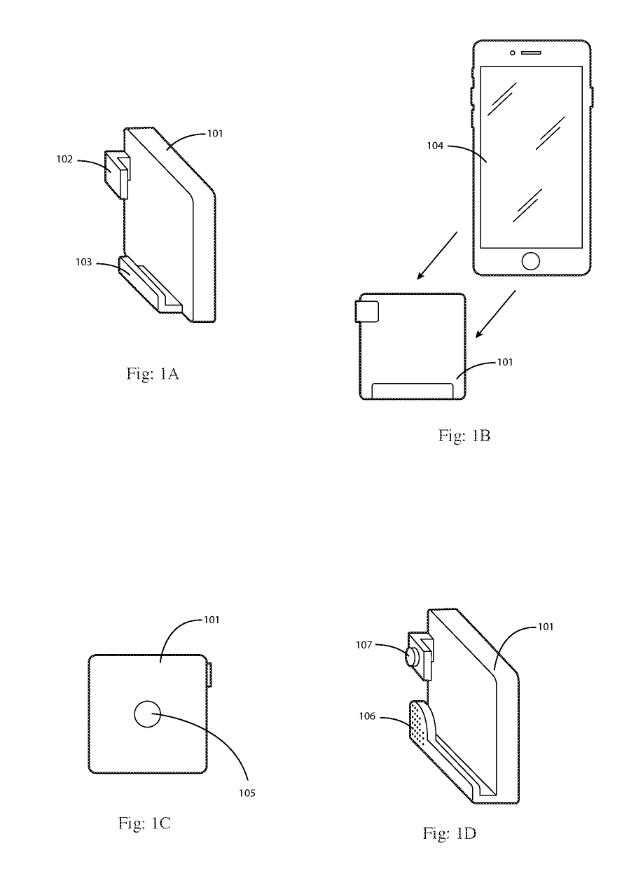

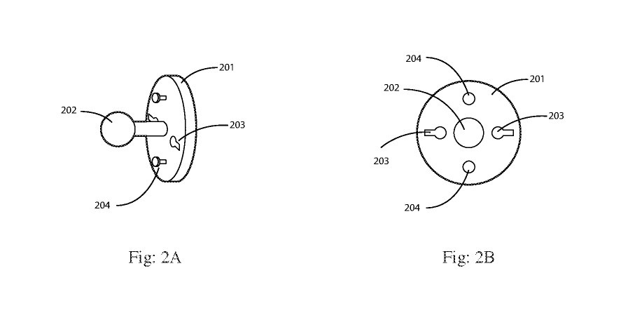

FIG. 1A is a perspective view of the device holder component 101 of the apparatus. 102 is a side lip to hold the mobile device from the side. 103 is a bottom lip to hold the device from the bottom. The two lips 102 and 103 secure the mobile device in the device holder component 101. Other designs for securing the mobile device into the device holder component 101 will be immediately obvious to those skillful in the arts.

FIG. 1B illustrates the insertion of a mobile device 104 into the device holder component 101.

FIG. 1C shows the back of the device holder component 101. 105 is a female ball socket joint at the back of the device holder component 101 to attach it to the other component of the disclosed apparatus.

1D shows another embodiment of the present invention where the device holder component 101 has built-in controls for the mobile device camera. The device holder component 101 establishes a Bluetooth or another type of connection with the mobile device. Once the connection is established, the 107 shutter timer button can be pressed to trigger the timer on the mobile device camera. 106 is a microphone for voice activation of the camera shutter or the camera shutter timer by pronouncing a voice command.

FIG. 2A is a perspective view of the mounting plate component 201 of the disclosed apparatus. 202 is a male ball socket joint that attaches to the female ball socket joint of the device holder component disclosed on FIG. 1C. 203 is keyhole for mounting the mounting plate component 201 on surfaces, such as walls, or to attach to it other mounting attachments disclosed further in this specification. 204 is a knob to interlock the mounting plate component 201 to other attachments for the apparatus. 203 and 204 create a versatile system to attach various attachments disclosed further in this specification that expand the usage of the apparatus in different settings.

FIG. 2B is a front view of the mounting plate component 201. 203 shows the two symmetrically positioned keyholes. 204 shows the two symmetrically positioned knobs for interlocking other attachments to the mounting plate component 201. 202 is a front view of the male ball socket joint.

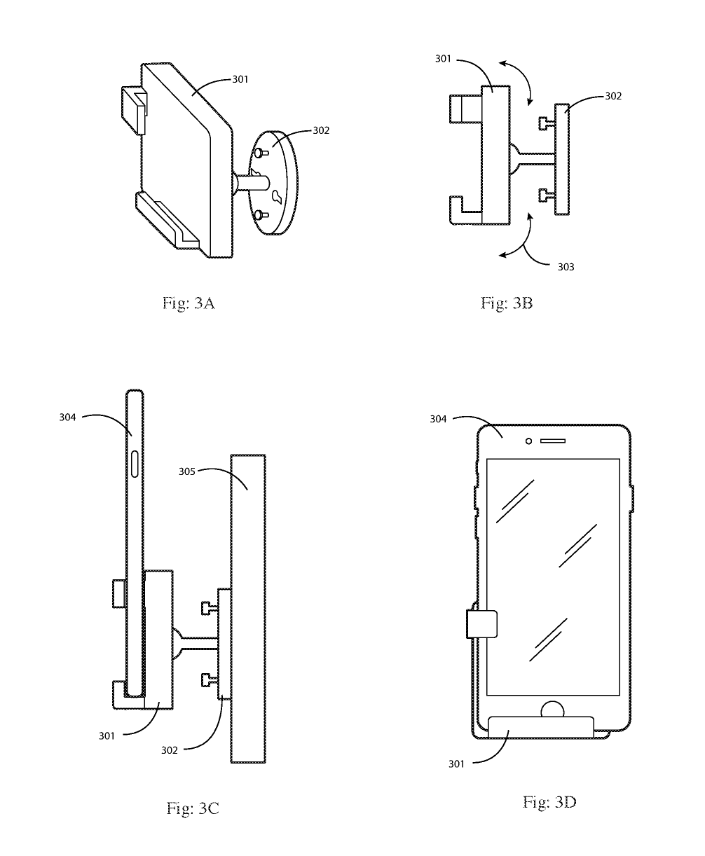

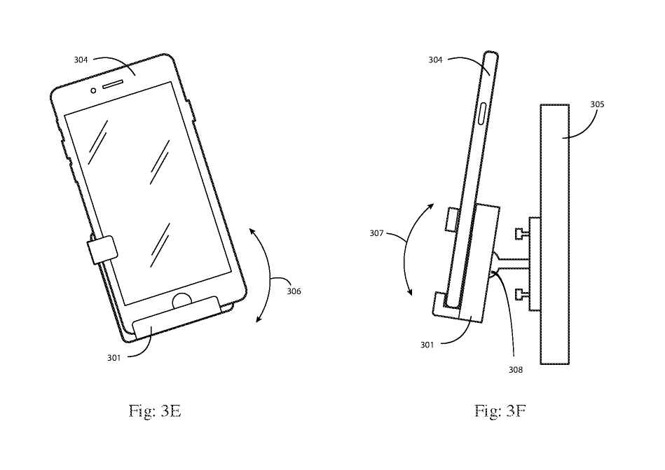

FIG. 3A is a perspective view of the device holder component 301 attached to the mounting plate component 302.

FIG. 3B is a side view of the device holder component 301 attached to the mounting plate component 302. The bidirectional arrow 303 indicates the rotation capabilities of the device holder component 301 around the head of the male ball socket joint that is shown on FIG. 2A.

FIG. 3C is a side view of a wall-mounted apparatus holding a mobile device 304. The mounting plate component 302 is permanently attached to a wall 305 using screws inserted into the keyholes shown on FIG. 2A and FIG. 2B. The device holder component 301 is attached to the mounting plate component 302 and the mobile device 304 is inserted into it.

FIG. 3D is a front view of the wall-mounted apparatus shown on FIG. 3C showing the mobile device 304 in the device holder component 301.

FIG. 3E is a front view of the apparatus showing the left to right rotation 306 of the device holder component 301 and the mobile device 304 inserted in it.

FIG. 3F is a side view of the apparatus attached to a wall 305. 307 illustrates the front to back rotation of the device holder component 301 and the mobile device 304 inserted in it around the ball shaped male joint 308.

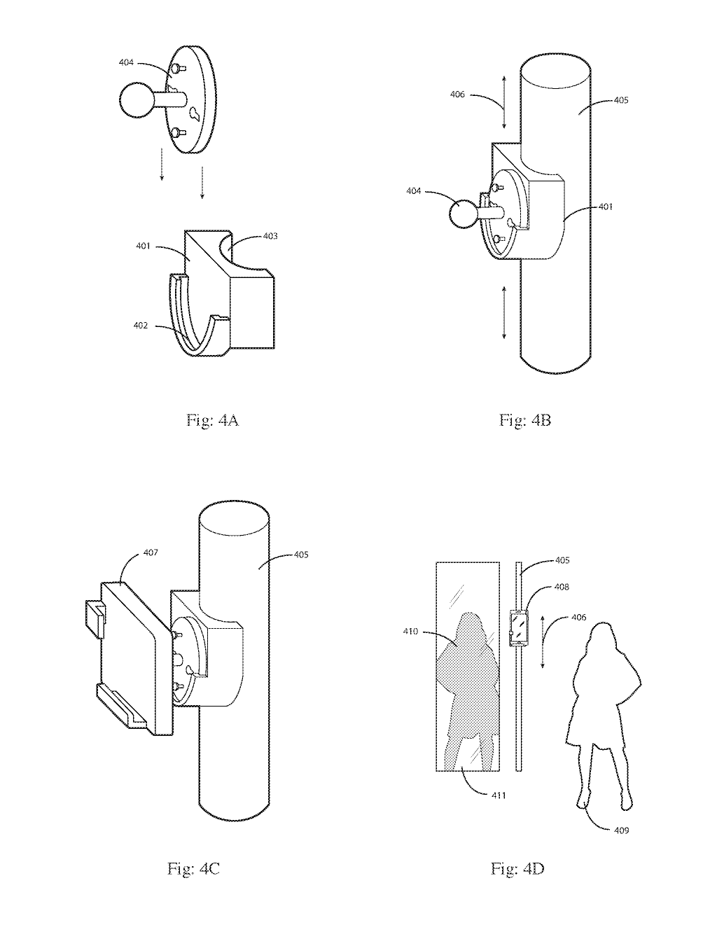

FIG. 4A shows a railing rider attachment 401 to mount the apparatus to a metal pole. 402 is a groove to interlock the mounting plate component 404 to the railing rider attachment 401. 403 is a magnetic surface to snap the railing rider attachment 401 to the metal pole.

FIG. 4B shows the railing rider attachment 401 mounted on a metal pole 405 to freely adjust its vertical position. The mounting plate component 404 is inserted into the railing rider attachment 401. 406 indicates the up and down movement of the railing rider attachment 401 along the metal pole 405.

FIG. 4C shows the apparatus 407 mounted on a metal pole 405.

FIG. 4D shows a user 409 taking a selfie with the apparatus 408. The apparatus 408 is mounted on a metal pole 405 installed on the side of a mirror 411. The user can view her reflection 410 in the mirror 411 in order to adjust her posture. 406 indicates that the apparatus 408 can be moved up and down the metal pole 405 to adjust the vertical angle for the picture in order to create different portrait effects.

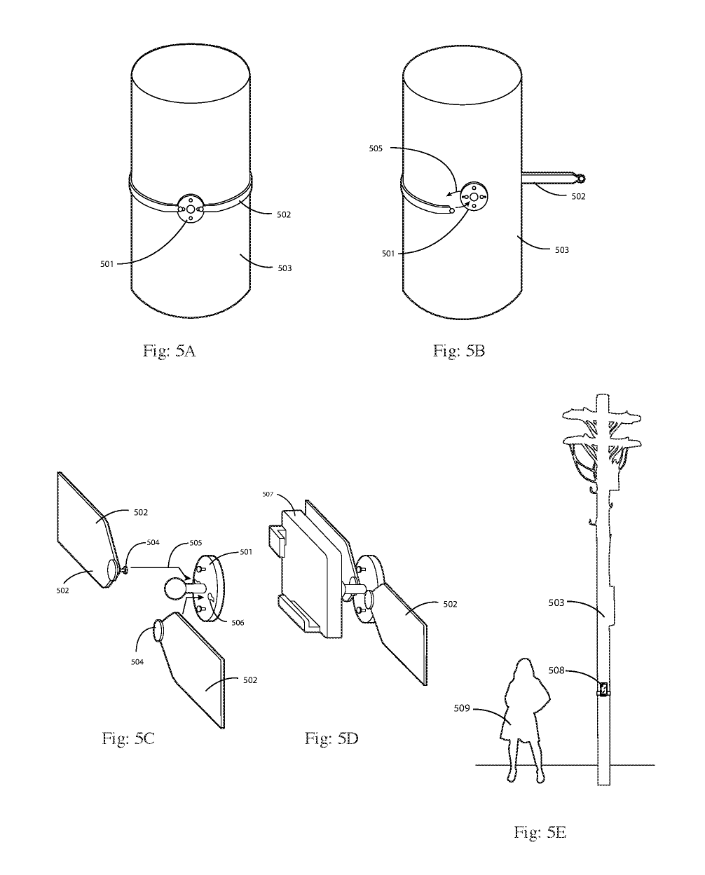

FIG. 5A shows the mounting plate component 501 mounted on a pole 503 via an elastic band attachment 502.

FIG. 5B shows the mounting of the mounting plate component 501 on the pole 503. The elastic band attachment 502 is wrapped around the pole 503 and its endings are being connected 505 to the mounting plate component 501 to temporally mount the apparatus on the pole 503.

FIG. 5C shows in detail the connection of the elastic band attachment 502 to the mounting plate component 501. Two pin connectors 504 attached to each end of the elastic band attachment 502 are inserted 505 into the keyholes 506.

FIG. 5D shows the apparatus 507 attached to the elastic band attachment 502.

FIG. 5E shows a user 509 taking a selfie outdoors with the apparatus 508 mounted temporarily on a pole 503.

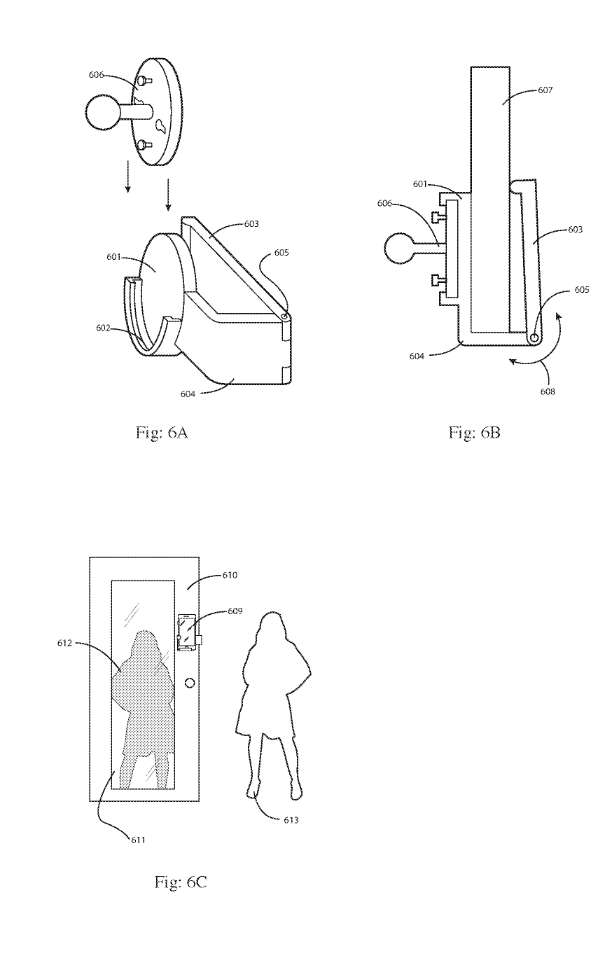

FIG. 6A shows a clamp attachment 601 for the apparatus. 602 is an interlocking groove on the clamp attachment 601 for inserting and securing the mounting plate component 606. 604 is 90-degree arm to hold the edge of an object, as for example the edge of a door. 603 is a spring loaded back flap. 605 is a spring loaded joint connecting the spring loaded back flap 603 to the 90-degree arm 604. The spring joint 605 allows attaching the clamp attachment 601 to edges with different widths.

FIG. 6B is a top view of the clamp attachment 601 attached to the edge of a door 607. The 90-degree arm 604 is perfectly aligned with the edge of the door 607. The spring joint 605 has a rotational movement 608 that allows to open and close the spring loaded back flap 603 in order to attach the clamp attachment 601 to edges with different widths.

FIG. 6C shows a woman 613 taking a selfie in front of a door 610 mounted mirror 611. The apparatus 609 is mounted on the door edge with the clamp attachment shown on FIG. 6A and 6B. 612 is the reflection of the woman 613 in the mirror 611.

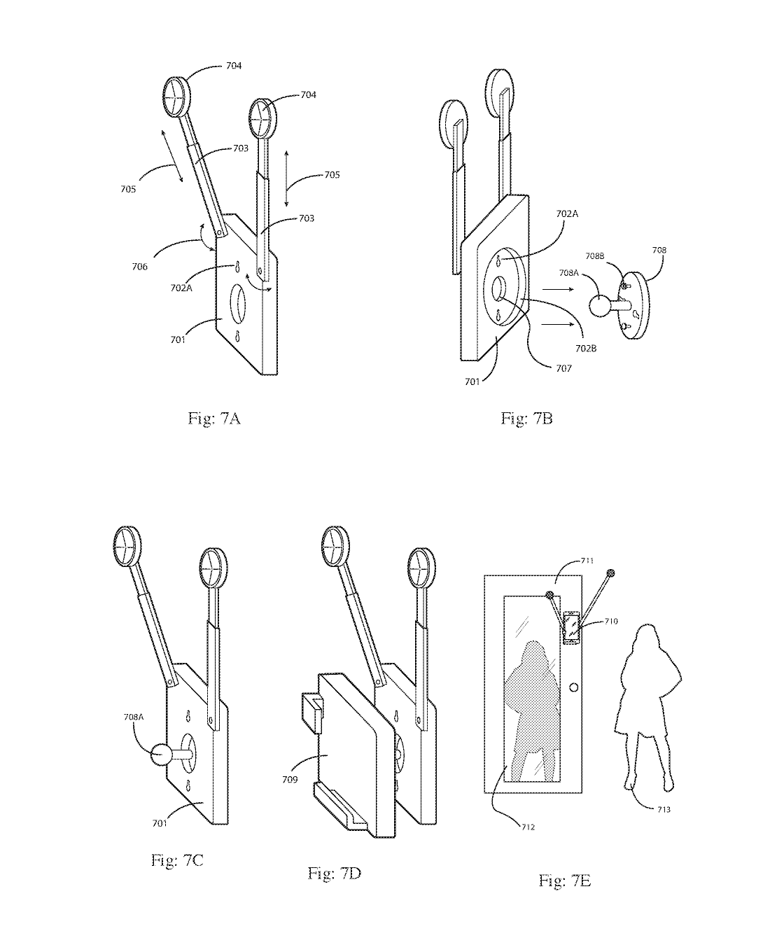

FIG. 7A shows a photo lighting attachment 701. 703 are two expandable arms to hold two light sources 704. The arrows 705 indicate the expansion path of the expandable arms 703. Arrow 706 indicates the left or right rotation of the expandable arms 703. 702A are two keyholes to interlock to the mounting plate component shown on FIG. 2A and FIG. 2B.

FIG. 7B shows connecting the photo lighting attachment 701 to the mounting plate component 708. 702A is a keyhole on the photo lightening attachment 701 that interlocks with the knob 708B on the mounting plate component 708. 702B is a cavity at the back of the photo lightening attachment 701 to house the mounting plate component 708. 707 is a hole on the photo lightening attachment 701 for the male ball shaped joint 708A to go through.

FIG. 7C shows the attached photo lighting attachment 701 to the mounting plate. The mounting plate component is housed within the back cavity shown on FIG. 7B of the photo lighting attachment 701 and only the male ball shaped joint 708A sticks out to attach to it the device holder component shown on FIG. 1A.

FIG. 7D shows the device holder component 709 being attached to a mounting plate component with attached photo lightening attachment.

FIG. 7E illustrates how a user 713 takes a selfie with the apparatus 710 attached to a door 711 with a mirror 712 using the clamp attachment described on FIG. 6A and FIG. 6B and the photo lighting attachment described on FIG. 7A.

1. A mountable selfie apparatus for remote photography comprising:
a mobile device holder with a ball socket joint insert;
a mounting plate with a spherical male ball socket joint that attaches to the ball socket insert of the mobile device holder.

2. The apparatus of claim 1 wherein the ball socket allows for left and right rotation of the device holder.

3. The apparatus of claim 1 wherein the ball socket allows for forward and backward rotation of the device holder.

4. The apparatus of claim 1 further comprising two keyholes on the mounting plate for connecting a mounting attachment.

5. The mounting attachment of claim 4 comprising an elastic band with two pins at each end of the elastic band to connect the elastic band to the keyholes of the mounting plate.

6. The mounting attachment of claim 4 comprising an edge clip with an interlocking groove for securing the mounting plate.

7. The apparatus of claim 1 further comprising two interlocking knobs on the mounting plate for connecting a photography enhancing attachment.

8. The photography enhancing attachment of claim 7 comprising a flashlight.

9. The photography enhancing attachment of claim 8 wherein the angle and height of the flashlight can be varied.

10. The photography enhancing attachment of claim 8 having more than one flashlight.

11. The apparatus of claim 1 further comprising embedded sensors in the mobile device holder for remote activation of a mobile device camera shutter.

12. A mountable selfie apparatus for remote photography comprising:
a mobile device holder with a ball socket joint insert;
a mounting plate with a spherical male ball socket joint that attaches to the ball socket insert of the mobile device holder;
an interlocking system for a mountable attachment; and
an interlocking system for a photography enhancing attachment.

13. The apparatus of claim 12 wherein the ball socket joint allows for left, right, backward and forward rotation of the mobile device holder.

14. The apparatus of claim 12 wherein the interlocking system for the mountable attachment comprises two keyholes on the mounting plate connecting to two pins on the mountable attachment.

15. The apparatus of claim 12 wherein the interlocking system for the mountable attachment comprises an interlocking groove on the mountable attachment for securing the mounting plate.

16. The apparatus of claim 12 wherein the interlocking system for the photography enhancing attachment comprises two knobs on the mounting plate connecting to two holes on the photography enhancing attachment.

17. The apparatus of claim 12 wherein the mountable attachment comprises an elastic band for securing the apparatus to a pole.

18. The apparatus of claim 12 wherein the mountable attachment comprises an edge clip for securing the apparatus to an object edge.

19. The apparatus of claim 12 wherein the photography enhancing attachment comprises an adjustable flashlight.

20. The apparatus of claim 12 further comprising embedded sensors for remote activation of a mobile device camera shutter.
